(19) United States
(12) Patent Application Publication
(10) Pub. No.: US 2006/0137962 A1
(43) Pub. Date: Jun. 29, 2006

(54) Remote power control switch assembly

(76) Inventors: Robert Schluter, Tavernier, FL (US); James Herrick, Wanaque, NJ (US); Richard King, Boonton Township, NJ (US)

Correspondence Address: Robert E. Cannuscio;Drinker, Biddle & Reath LLP, One Logan Square, 18th and Cherry Streets, Philadelphia, PA, 19103-6996, US

(21) Appl. No.: 11/023,066

(22) Filed: Dec. 27, 2004

(51) Int. Cl. H01R 13/70

(52) U.S. Cl. 200/51 R

(57) ABSTRACT

A remote electrical power control switch assembly for controlling power to a controlled device includes an electrical switch having a lever actuator. The switch is changed between an off state and an on state by movement of the lever between a first position and a second position, respectively. A key or lever operated cam lock includes a cam which operatively couples the cam lock to the switch lever. The cam lock is manually rotatable about a central axis between a first position wherein power is not provided to the controlled device and a second position wherein power is provided to the controlled device. The switch assembly preferably includes a piggyback plug adapted to be inserted into an electrical outlet and adapted to receive a second plug operatively coupled to the controlled device. The remote switch assembly may comprise a first and second mounting brackets.

### FIELD OF THE INVENTION

The invention relates to electrical power control switches.

### BACKGROUND OF THE INVENTION

It is known to use electrical power control switches that are located remotely from the device being controlled by the switch. For example, U.S. Pat. No. 6,504,117 (Overstreet)-discloses a foot-operated electrical switch for controlling power to a controlled device. In particular, a user of the device of the '117 patent uses his or her foot to apply a generally horizontal force to a pivot plate to activate the switch.

While the device in the '117 patent provides an improved system for controlling power to a device, it is limited in its ability to provide any degree of security for preventing use of the device. Also, while there are other types of electrical switches on the market, those switches are generally very costly and complex.

A need exists for an improved, inexpensive, manually-operated remote power control switch which provides increased tamper resistance.

### SUMMARY OF THE INVENTION

In a first aspect, the invention is directed to a remote electrical power control switch assembly for controlling power to a controlled device. The remote switch assembly comprises a housing having at least one wall. An electrical switch is supported by and enclosed within the housing. The switch has a first actuator movable between a first position and a second position. The first actuator is preferably biased into the first position. The switch is changed between an off state and an on state by movement of the first actuator between the first position and the second position, respectively.

A second actuator is mounted within the at least one wall. The second actuator preferably has a central axis substantially perpendicular to the at least one wall. The second actuator includes a cam operatively coupling the second actuator to the first actuator. A portion of the second actuator is accessible from an exterior of the housing. The second actuator is manually rotatable about the central axis between a first position and a second position.

A power input conductor is operatively coupled to the switch. A power output conductor is operatively coupled to the switch and is connectable to the controlled device. With the second actuator in its first position, the switch is in the off state, and electrical power is not provided to the power output conductor. With the second actuator in its second position, the switch is in the on state, and electrical power is provided to the power output conductor.

Preferably, the remote switch assembly further comprises a piggyback plug having prong terminals adapted to be inserted into an electrical outlet and having prong terminal receptacles adapted to receive prong terminals of a second plug that is operatively connected to the controlled device. A cord operatively connects the piggyback plug to the electrical switch. The cord includes the power input conductor and the power output conductor.

In one preferred embodiment, the first actuator is a lever and the second actuator is either a keyed cam lock or a keyless cam lock. The remote switch assembly may include a first mounting bracket adapted to mount the assembly to a flat surface and second mounting bracket adapted to mount the assembly to a decorator-style face plate or panel. The housing walls may be permanently joined to prevent access to and tampering of the electrical switch.

The present invention allows for individual components (e.g., switch and actuator) of the device to be easily replaced.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

For the purpose of illustrating the invention, there is shown in the drawings forms of the invention which are presently preferred; it being understood, however, that this invention is not limited to the precise arrangements and instrumentalities shown. In the drawings:

FIG. 1 is a perspective view of a remote electrical power control switch assembly in accordance with a first preferred embodiment of the present invention partially illustrating, in block diagram form, a controlled device for use with the switch assembly.

FIG. 2 is an exploded front perspective view of the switch assembly of FIG. 1.

FIG. 3 is an exploded rear perspective view of the switch assembly of FIG. 1.

FIG. 4 is a top plan view of the switch assembly of FIG. 1, shown with a housing cover removed.

FIG. 5 is a perspective view of a remote electrical power control switch assembly in accordance with a second preferred embodiment of the present invention, illustrating mounting of the switch assembly using a first mounting bracket.

FIG. 6 is a perspective view of the switch assembly of FIGS. 1-4, illustrating mounting of the switch assembly using a second mounting bracket.

FIG. 7 is a schematic view of the switch assembly of FIG. 1 mounted within a wall mounted rack and engaged with a solenoid lock.

FIG. 8 is a schematic view of the wall mounted rack with its center section pivoted away from its backpan.

### DETAILED DESCRIPTION OF THE DRAWINGS

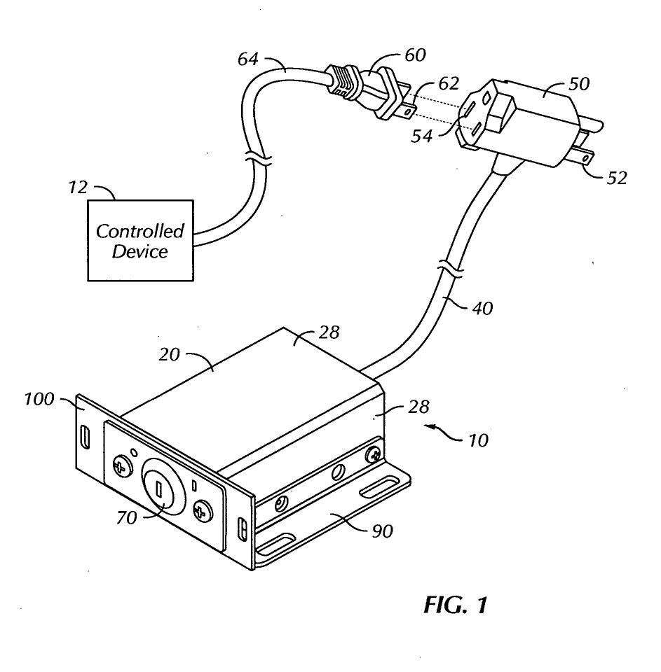

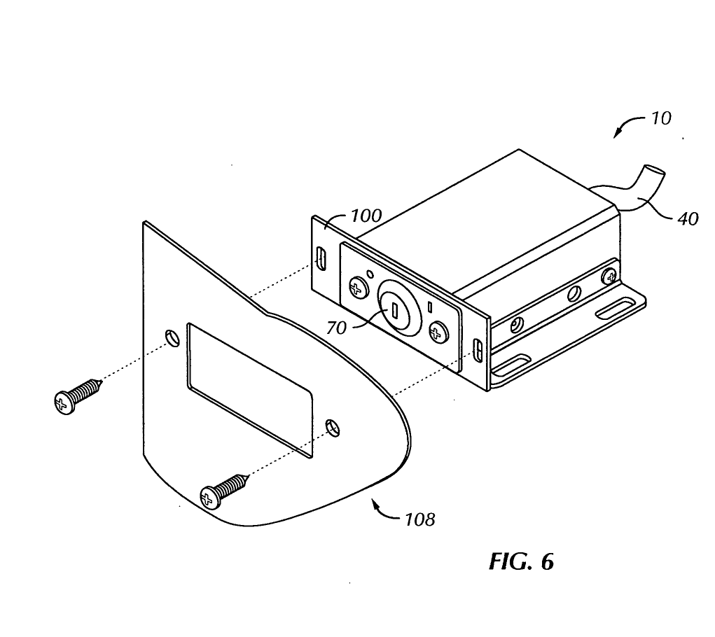

Referring to the figures, wherein like numerals are used to indicate like elements throughout, there is shown in FIGS. 1-6 first and second embodiments of a remote electrical power control switch assembly for controlling power to a controlled device. While two embodiments are shown, those skilled in the art would be readily capable of varying aspects of the invention in light of the teachings provided herein. With particular reference to FIGS. 1-4 and 6, a first embodiment of the remote electrical power control switch assembly 10 (or “switch assembly”) preferably comprises a housing 20, an electrical switch 30, a cord 40, a piggyback plug 50, a key lock actuator 70, a cam 80, a first mounting bracket 90 and a second mounting bracket 100. The switch assembly 10 allows power to a controlled device 12 to be manually switched on and off.

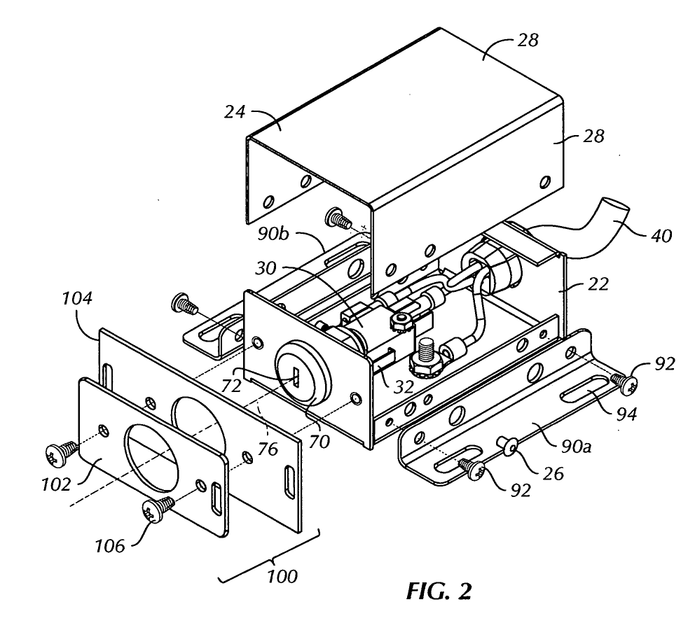

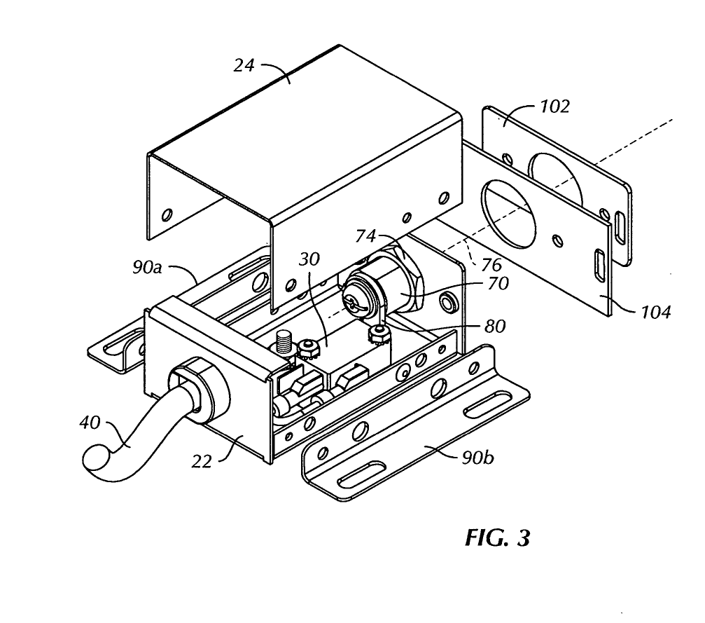

The housing 20 has at least one wall and preferably a plurality of walls 28. With particular reference to FIGS. 2 and 3, the housing 20 includes a base 22, having a bottom and two end walls, and a cover 24, having a top and two side walls. Preferably, the base 22 and cover 24 are permanently joined together to prevent access to and tampering of the electrical switch 30. Rivets 26 may be used to join the base 22 and cover 24, although other joining techniques, such as welding, could also be used.

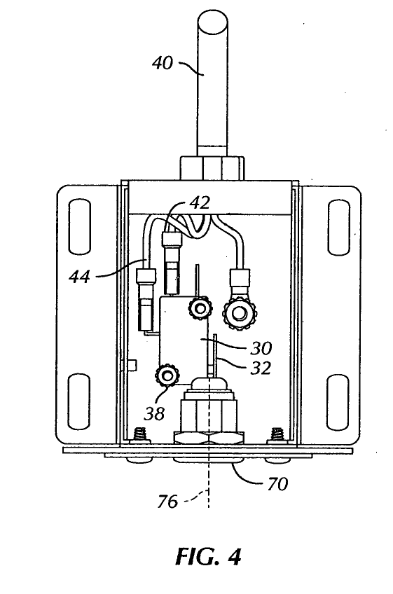

With continued reference to FIGS. 2 and 3, as well as FIG. 4, the electrical switch 30 is supported by and enclosed within the housing 20. Preferably, the electrical switch is connected to the housing using attachment nuts 38. The switch 30 is conventional, and may be a commercially-available off-the-shelf item. One suitable switch 30 for use with the present invention is a model V7-1V19E9 switch available from Honeywell International, Inc., Morristown, N.J. Other commercially available switches may also be used. The switch 30 has a first actuator, preferably in the form of a lever 32. The lever 32 is movable between a first position and a second position. The lever 32 is preferably biased into the first position. The switch 30 is changed between an off state and an on state by movement of the lever between the first position and the second position, respectively. While the illustrated embodiment utilizes a lever to actuate the switch, other forms of switch actuation mechanisms, such as depressible button or rotary actuators, can be utilizes in the present invention.

A power input conductor 42 is operatively coupled to the switch 30, for supplying electrical current to the switch 30. A power output conductor 44 is also operatively coupled to the switch 30 and is connectable to the controlled device 12 for providing electrical current to the controlled device 12. Preferably, the input and output conductors are combined into the cord 40.

As shown in FIG. 1, the present invention preferably includes a piggyback plug 50 which is connected to the switch 30 through the cord 40. The piggyback plug 50 has prong terminals 52 adapted to be inserted into an electrical outlet (not illustrated) in a conventional manner. The piggyback plug 50 also has prong terminal receptacles 54 adapted to receive prong terminals for a power cord connected to the controlled device 12. For example, as shown in FIG. 1, the controlled device 12 includes a convention power cord 64 with a second plug 60. The second plug 60 preferably includes conventional prong terminals 62 that engage with the receptacles 54 on the piggyback plug 50.

A second actuator, preferably in the form of a keyed cam lock 70, is mounted within a wall 28 of the housing 20. The keyed cam lock 70 is a commercially available item, for example, a full-size flat keyed cam lock available from Royal Lock Inc. of Waucond, Ill. The keyed cam lock 70 includes a keyhole 72, and is held secure to the first wall, preferably by a lock nut 74. The keyed cam lock 70 has a central axis 76. The central axis 76 is substantially perpendicular to the wall. A portion of the second actuator (preferably the keyhole 72) is accessible from an exterior of the housing 20. The keyed cam lock 70 is manually rotatable about the central axis 76 between a first position and a second position. With reference to FIG. 1, preferably the keyed cam lock 70 rotates approximately 90 degrees between the first position (corresponding to the position marked “O” adjacent the keyhole 72) and the second position (corresponding to the position marked “I” adjacent the keyhole 72).

The keyed cam lock 70 includes a cam 80 which operatively couples the keyed cam lock 70 to the switch lever 32. The cam 80 is preferably designed to contact the lever 32 over a relatively large area, to reduce stresses in the lever 32 resulting from contact with the cam 80, thus helping to ensure reliable and extended performance of the switch assembly 10. Further, the cam 80 is designed to provide a measure of over-travel when the keyed cam lock 70 is moved into the second position. The over-travel ensures that the lever 32 is moved fully into its second position to activate the switch 30.

With the keyed cam lock 70 in its first position, the switch 30 is in the off state, and electrical power cannot provided to the power output conductor 44. With the keyed cam lock 70 in its second position, the switch 30 is in the on state, and electrical power can be provided to the power output conductor 44. As the cam lock 70 is actuated from its first to second position, the cam rotates about the central axis 76, contacting and urging the lever 32 to transition from its first position to its second position. It should be readily apparent that if the lever 30 were, instead, a depressible button, the rotation of the cam lock would be arranged to cause depression of the button.

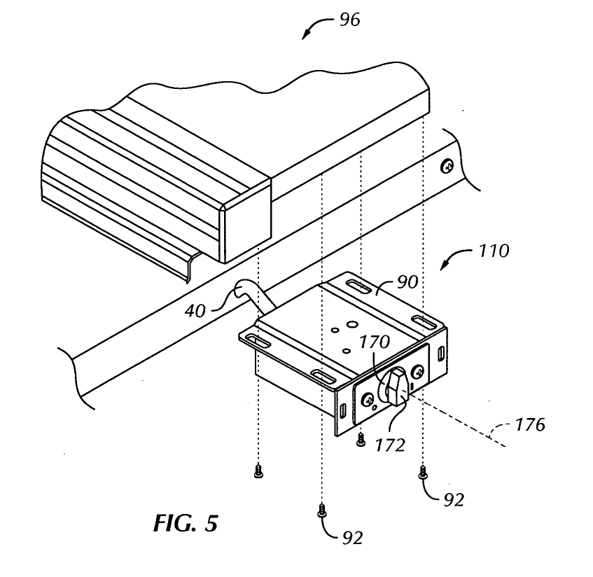

Preferably, the switch assembly 10 further includes a first mounting bracket 90 adapted to mount the switch assembly 10 to a flat surface, and second mounting bracket 100 adapted to mount the assembly to a decorator-style face plate or panel. The first mounting bracket 90 preferably comprises a left-hand bracket 90a and a right-hand bracket 90b. Each bracket 90a, 90b is preferably removably connected to the housing 20 by screws 92, although the brackets could be fixedly attached if desired. Each bracket 90a, 90b is further provided with elongated slots 94 through which additional screws 92 connect the switch assembly 10 to a flat surface. With particular reference to FIG. 5, the switch assembly 10 may be, for example, mounted to the underside of a planar surface 96.

With particular reference now to FIGS. 2, 3, and 6, the second mounting bracket 100 preferably comprises a face plate 102 and a sub-plate 104. Screws 106 releasably connect the face plate 102 and sub-plate 104 to the housing 20. The second mounting bracket 100 is specifically adapted for use with a so-called “decorator style” switch face plate 108. Such face plates 108 are adapted for use with DECORA switches. (DECORA is a trademark of the Leviton Manufacturing Company, Inc.) However, it should be readily apparent that the present invention is not limited to use with any particular switch plates. Also, while the figures illustrate one embodiment of the switch, it should be readily apparent that the switch can be mounted in many different forms of racks or panels. The mounting hardware also permits the switch to be mounted to any form of substrate, such as metal, wood or plastic.

With reference again to FIG. 5, a second embodiment of the remote electrical power control switch assembly 110 is shown and is structurally and functionally similar to the first embodiment switch assembly 10, with the exception that the second actuator is not a keyed cam lock 70 but rather a keyless cam lock 170, having an actuator operating lever 172. The keyless cam lock 170 is conventional, and is preferably a commercially-available item, such as, for example a TL600 series lever-operated latch available from Royal Lock Inc. of Waucond, Ill. The keyless cam lock 170 operates similarly to the keyed cam lock 70, being manually rotated about a central axis 176 between a first “off” position and a second “on” position.

It will be recognized that other types of rotating actuators could be employed as the second actuator, in substitution for the keyed cam lock 70 or the keyless cam lock 170. Any type of rotating actuator capable of being coupled to the switch first actuator (the lever 32) to move the first actuator from a first, un-activated position to a second, activated position, could be substituted.

In operation, the second actuator (keyed cam lock 70 or keyless cam lock 170) is rotated into the first position (if not already in the first (or off) position). The piggyback plug 50 is then inserted into a live electrical outlet (not shown). The second plug 60 is then installed into the piggyback plug 50. At this point, power is not supplied to the second plug 60. When power to the controlled device 12 is desired, the second actuator is moved to the second position which, in turn, activates the switch 30 allowing electrical power to be supplied to the second plug 62. When power to the controlled device 12 is not desired, the second actuator is moved to the first position, thereby deactivating the switch 30 and inhibiting electrical power to the second plug 62.

The present invention provides an inexpensive manually-operated remote power control switch assembly. The switch assembly provides a novel arrangement of simple and robust mechanisms capable of controlling power to a controlled device. In a first embodiment, activation of the switch is controlled by the keyed cam lock, while in a second embodiment, activation of the switch is controlled by rotation of the keyless cam lock.

The present invention has particular use in rack systems that have two access modes. For example, a wall mounted rack, such as the DWR series rack sold by Middle Atlantic Products, Inc., Riverdale, N.J., includes a front hinged door and a center cabinet section that can be swung out from a backpan. Separate mechanical locks are generally used to lock the front door to the center section, and the center section to the backpan. The lock for engaging the center section to the back pan is normally located on the side of the unit. However this type of configuration inhibits side-by-side mounting of units.

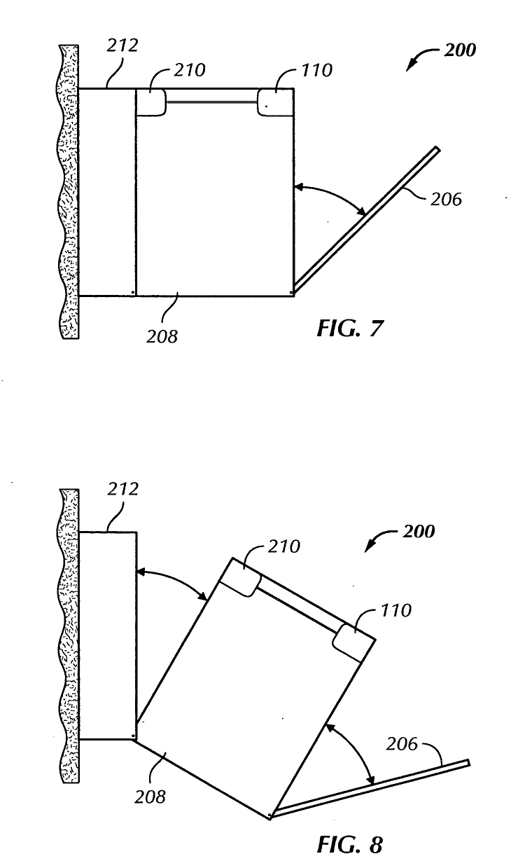

The present invention provides a unique solution to this problem. By combining mechanical and electrical switches, it is possible to remotely locate the switch from the lock. For example, referring to FIGS. 7 and 8, in the wall mounted rack 200, the second embodiment switch assembly 110 could be located on the front of the unit, such as on or near the front door 206 or on the front of the center cabinet 208. The first embodiment switch assembly 10 could also be used. The controlled device could be a conventional electromechanical lock 210, such as a solenoid actuation lock, that is located on the back of the center cabinet 208 and which includes a latch that engages with the backpan 212. The present invention would control supply of electrical power to the solenoid lock 210 to unlock the center cabinet section 208 from the backpan 212, thus allowing the center cabinet section 208 to be pivoted away to permit access to the back of the cabinet (see FIG. 8).

Although the invention has been described and illustrated with respect to the exemplary embodiments thereof, it should be understood by those skilled in the art that the foregoing and various other changes, omissions and additions may be made therein and thereto, without parting from the spirit and scope of the present invention. Accordingly, reference should be made to the appended claims, rather than to the foregoing specification, as indicating the scope of the invention.

1. A remote electrical power control switch assembly for controlling power to a controlled device, the remote switch assembly comprising:
a housing having at least one wall;
an electrical switch mounted to the housing, the switch having a first actuator movable between a first position and a second position, wherein the switch is changed between an off state and an on state by movement of the first actuator between the first position and the second position, respectively;
a second actuator mounted to the housing, the second actuator having a central axis, the second actuator including a cam mechanism operatively coupling the second actuator to the first actuator, wherein a portion of the second actuator is accessible from an exterior of the housing, and the second actuator is manually rotatable about the central axis between a first position and a second position;
a power input conductor operatively coupled to the switch;
a power output conductor operatively coupled to the switch and connectable to the controlled device; and
a receptacle adated for receiving a plug of a controlled device, the receptacle located remotely from the electrical switch,
wherein with the second actuator in the first position, the switch is placed in the off state, and electrical power is not provided to the power output conductor, and
wherein with the second actuator in the second position, the switch is placed in the on state, and electrical power is provided to the power output conductor.

2. The remote switch assembly of claim 1, further comprising a piggyback plug having prong terminals adapted to be inserted into an electrical outlet and having prong terminal receptacles adapted to receive prong terminals of a second plug operatively coupled to the controlled device, and a cord operatively connecting the piggyback plug to the electrical switch, the cord including the power input conductor and the power output conductor.

3. The remote switch assembly of claim 1, wherein the first actuator is a lever.

4. The remote switch assembly of claim 1 further comprising a first mounting bracket for mounting the housing.

5. The remote switch assembly of claim 4 wherein the first mounting bracket is adapted to mount to a flat surface.

6. The remote switch assembly of claim 4 further comprising a second mounting bracket for mounting the housing.

7. The remote switch assembly of claim 6 wherein the second mounting bracket is adapted to mount to a decorator-style face plate.

8. The remote switch assembly of claim 1 wherein the second actuator is a keyed cam lock.

9. The remote switch assembly of claim 1, wherein the second actuator is a keyless cam lock.

10. The remote switch assembly of claim 1 wherein the housing has a plurality of walls that enclose the switch, the walls being permanently joined to prevent access to and tampering of the electrical switch.

11. The remote switch assembly of claim 10 wherein the housing walls are riveted together.

12. The remote switch assembly of claim 1 wherein the first actuator of the switch is biased into the first position.

13. A remote mechanical-electrical power control switch assembly for controlling power to a controlled device, the remote switch assembly comprising:
a housing;
an electrical switch mounted to the housing, the switch having a first actuator movable between a first position and a second position, the first actuator being biased into the first position, and wherein the switch is changed between an off state and an on state by movement of the first actuator between the first position and the second position, respectively;
a mechanical second actuator mounted to the housing, the second actuator having a central axis, the second actuator including a cam mechanism which is operatively connected to the first actuator such that rotation of the cam mechanism causes the first actuator to move between its first and second positions, the second actuator having a manual activation mechanism which is accessible from outside the housing and is connected to the cam mechanism, the manual activation mechanism being rotatable about the central axis between a first position and a second position, the rotation of the activation mechanism causing concurrent rotation of the cam;
a power input conductor operatively coupled to the switch; and
a power output conductor operatively coupled to the switch and connectable to the controlled device; and
a receptacle adapted for receiving a plug of a controlled device, the receptacle located remotely from the electrical switch,
wherein with the second actuator in the first position, the switch is placed in the off state, and electrical power is not provided to the power output conductor, and
wherein with the second actuator in the second position, the switch is placed in the on state, and electrical power is provided to the power output conductor.

14. The remote switch assembly of claim 13, wherein the housing for the electrical switch is mounted within a rack assembly having a cabinet and a backpan, the cabinet pivotably connected to the backpan adjacent a back end of the cabinet, and wherein the controlled device is an electro-mechanical lock mechanism providing latched and unlatched conditions for the rack assembly for respectively disabling and enabling pivoting of the cabinet from the backpan.

15. The remote switch assembly according to claim 14, wherein the housing for the switch assembly is mounted to the cabinet such that the manual actuation mechanism of the second actuator is located adjacent a front end of the cabinet.

16. The remote switch assembly according to claim 14, wherein the electro-mechanical lock mechanism includes a solenoid actuator.

17. The remote switch assembly of claim 1 wherein the receptacle is accessible whether the switch is in the first or second positions.
